(19) United States
(12) Patent Application Publication
(10) Pub. No.: US 2006/0082115 A1
(43) Pub. Date: Apr. 20, 2006

(54) Energy absorption device and passenger safety crossbar system incorporating same

(76) Inventors: John Marshall, British Columbia (CA); Herbert Bentz, British Columbia (CA); Ryan Andrew Holmes, British Columbia (CA); Geoffrey Mchael Wood, British Columbia (CA)

Correspondence Address: MOORE & VAN ALLEN PLLC, P.O. BOX 13706, Research Triangle Park, NC, 27709, US

(21) Appl. No.: 10/513,258

(22) PCT Filed: Apr. 30, 2003
(86) PCT No.: PCT/CA03/00619

§ 371 Date: Oct. 24, 2005

(30) Foreign Application Priority Data
Apr. 30, 2002 (CA) 2384038

(51) Int. Cl. B60R 21/02

(52) U.S. Cl. 280/748

(57) ABSTRACT

An energy absorption device comprises an elongated base member (22) and an elongated mechanically fused spring arm (30) extending longitudinally from a first end (32) secured to the base member to a free distal end (34). The spring arm has resilience for storing mechanical energy when flexed from a normally unflexed position' to a flexed position. During such movement, the resistance offered by the mechanical fusing must be overcome. Thus the device serves both to store and to dissipate mechanical energy. Suitable fusing mechanisms include shear pins and mechanical fuse strips (40). A system comprising a passenger safety crossbar (10) supported by a pair of such energy absorption devices is also disclosed.

### FIELD OF THE INVENTION

The present invention relates to energy absorption devices and to a system using same to protect vehicle passengers by absorbing crash energy.

### BACKGROUND TO THE INVENTION

In some vehicles, school buses being a particular example, safety devices such as ordinary seat belts or shoulder harnesses may be considered unsuitable not only because they may become a source of injury if not used properly but also because some of the young occupants may be disinclined to use the devices in the intended manner or at all.

In view of such considerations, various restraint systems which include a safety bar adapted to extend across the lap of seated passengers have been proposed for buses. These include the safety bar system described in U.S. Pat. No. 4,681,344 (Majerus) granted on Jul. 21, 1987, the restraint system described in U.S. Pat. No. 4,930,808 (Mikoll et al.) granted on Jun. 5, 1990, and the restraint apparatus described in U.S. Pat. No. 5,853,193 (Marshall) granted on Dec. 29, 1998. At least in the latter two cases, the systems described have a degree of flexibility or give beyond mere padding that serves to absorb the kinetic energy of a passenger who impacts the bar during a crash. But, if the amount of flexibility is designed with teenagers or adults in mind, the system may be excessively rigid for a six year old sitting alone or even with another six year old. Likewise, if the amount of flexibility is designed with a six year old in mind, the system may be too flexible for a teenager or adult or two teenagers or adults sitting together.

Accordingly, there is a need for a passenger safety crossbar system which can afford effective protection over a significant range of passenger weights. As well, there is a need for an energy absorption device that can be adapted to support a passenger safety crossbar and serve to protectively absorb energy transmitted to the device from a crash impact on the crossbar either from a relatively light passenger or from relatively heavy passengers.

### SUMMARY OF THE INVENTION

In a broad aspect of the present invention, there is provided an energy absorption device comprising an elongated base member, an elongated spring arm extending longitudinally from a first end secured to the base member to a distal end, the arm having resilience for storing mechanical energy when flexed from a normally unflexed position to a flexed position, and mechanical fuse means for providing fuse resistance to the flexing of the arm from the unflexed position to the flexed position. When the spring arm is in the unflexed position its distal end is relatively near the base member. When the spring arm is in the flexed position its distal end is relatively far from the base member.

Herein, the term “mechanical fuse” means an element which offers a predetermined amount of resistance (“fuse resistance”) to a mechanical force. When the resistance is overcome by a suitably high force, the fuse actuates by breaking or deforming in a destructive manner thereby dissipating mechanical energy. Thus, when the spring arm is flexed from the unflexed position to the flexed position, energy is absorbed and managed in two different ways. Firstly, by virtue of the arm's spring characteristic, mechanical energy is absorbed and stored in the arm. Secondly, since fuse resistance must be overcome in order to flex the arm from the unflexed position to the flexed position, mechanical energy is absorbed and dissipated by the mechanical fuse means. In any given case, the amount of energy absorbed and stored by the spring arm relative to the amount of energy absorbed and dissipated by the mechanical fuse means will depend upon the amount of fuse resistance.

In one embodiment, the spring arm is mechanically fused by an elongated mechanical fuse strip comprising a central portion extending lengthwise over the arm and a plurality of fuse tabs extending transversely outward from the central portion to the base member. Each of the tabs is secured to the base member for providing fuse resistance to the flexing of the arm from the unflexed position to the flexed position.

Advantageously, the central portion of the fuse strip and the tabs are integrally formed. Further, the central portion comprises opposed longitudinally extending first and second sides connected by crosspieces at spaced intervals. A first sub-plurality of the tabs extends transversely outward from the first side of the central portion, and a second sub-plurality of the tabs extends transversely outward from the second side of the central portion.

By directing the force of mechanical energy from an external source to the distal end of the spring arm such that the arm is flexed from its unflexed position to its flexed position, a part of the energy may be stored and another part dissipated.

The spring arm may be mechanically fused by other means, for example, by a plurality of shear pins secured at spaced intervals along the base member, each fuse extending over the arm for providing fuse resistance to the flexing of the arm from the unflexed position to the flexed position.

In some applications, it may be considered desirable to provide a stage of resistance beyond that offered by fuse resistance. Advantageously, a further stage of resistance is provided a flexible strap formed from seat belt or similar material. One end of the strap is connected to the base member and an opposed end is connected to the spring arm. The strap has a length sized to limit the arm from flexing beyond a predetermined maximum flexed position.

Energy storage devices as described above may be used in a variety of applications. In one such application, the distal end of the spring arm is adapted to carry an end of a passenger safety crossbar.

Accordingly, and in another aspect of the present invention, there is provided a system for protecting a passenger seated in a vehicle on a vehicle seat, the system comprising a passenger safety crossbar extending between opposed ends with each end being carried by the distal end of the spring arm of an energy absorption device as described above. In the present context, each energy absorption device may be referred to as a crossbar support. In practice, the spring arm and the crossbar include suitable padding.

The base member of each such crossbar support extends upwardly and rearwardly from a lower end mounted in the vehicle forward of the seat. Preferably, the mounting of at least one of the supports is a pivotal mounting which permits movement of the crossbar from a closed position protecting a passenger while seated in the seat to an open position permitting passenger access to and egress from the seat.

In a preferred embodiment where one of the base members is pivotally mounted, the system includes means for releasably latching the base members to a frame member of the seat. Further, the crossbar is formed from a resilient material for springing the crossbar to its open position when the base members is unlatched from the frame member.

The spring arm and fuse resistance provided by each crossbar support in the foregoing system may be designed to absorb a predetermined amount of energy. If the supports include flexible straps (as is preferably the case) to provide a further stage of resistance as described above then, in cases where the predetermined amount of energy is surpassed, further energy will be dissipated when the straps reach their maximum extensions.

It will be noted that the spring arms and the crossbar effectively serve to compartmentalize a passenger in his or her seat both in the unflexed and flexed positions of the spring arms. The compartmentalization is enhanced by the resilience of the spring arms which will serve to urge the arms toward their unflexed positions after deflection resulting from the impact of a passenger on the crossbar. Thus while a passenger will bear against the crossbar during a crash and may lift away from his or her seat as the crossbar moves with deflection of the spring arms, there will be a return force which will assist to return the passenger to his or her seat. The compartmentalization is enhanced by the flexible straps because they not only provide a second stage of resistance, but can act as a flexible barrier in the case of side impacts and angled impacts.

The foregoing and other features and advantages of the present invention will now be described with reference to the drawings.

### BRIEF DESCRIPTION OF THE DRAWINGS

FIG. 1 is an isometric view of the framework of a conventional bench seat on a bus and a passenger safety crossbar system, the system including a crossbar and a pair of energy absorbing crossbar supports in accordance with the present invention.

FIG. 2 is a side elevation view of the crossbar system illustrated in FIG. 1.

FIG. 3 is an isometric view as in FIG. 1, but showing the crossbar in an open position.

FIG. 4 is a side elevation view of the crossbar system illustrated in FIG. 3.

FIG. 5 is a section view showing the crossbar support in FIG. 2 in more detail.

FIG. 6 is an isometric view of one of the crossbar supports.

FIG. 7 is an end elevation view of the crossbar support shown in FIG. 6.

FIG. 8 is a top view of the crossbar support shown in FIG. 6.

FIG. 9 is a side elevation view of the crossbar support shown in FIG. 6.

FIG. 10 is a bottom view of the crossbar support shown in FIG. 6.

FIG. 11 is a top view of a mechanical fuse strip forming part of the crossbar support shown in FIG. 6.

FIG. 12 is a side elevation view that representationally shows the crossbar system in use during normal travel.

FIG. 13 is a side elevation view that representationally shows the crossbar system in use at a moment shortly after a crash has occurred.

FIG. 14 is a side elevation view that representationally shown the crossbar system in use at a subsequent moment after a crash has occurred.

FIG. 15 is an end view illustrating the natural, unstressed shape the crossbar shown in FIGS. 1-5.

### DETAILED DESCRIPTION

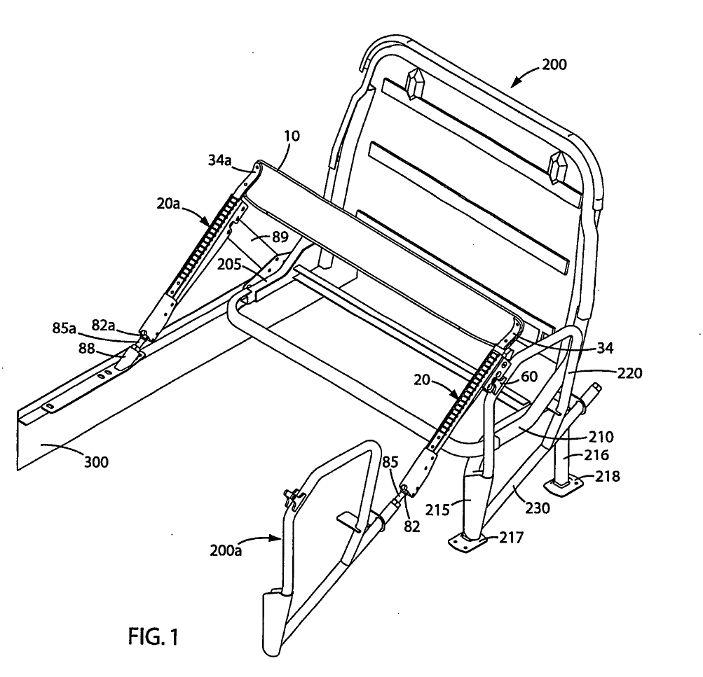

In FIG. 1, the framework of a bench seat generally designated 200 is shown together with a pair of energy absorbing crossbar supports generally designated 20, 20a. As well, FIG. 1 shows a portion of the framework of a similar bench seat generally designated 200a positioned immediately in front of seat 200. Conventional padding for seats 200, 200a is not shown in FIGS. 1-5. But, such padding is depicted in FIGS. 12-14.

Typically, a bus (not shown) will include a number of seats such as seats 200, 200a on one side of a passenger aisle, and a number of additional seats which are mirror images of seats 200, 200a on the other side of the passenger aisle. All views in FIGS. 1-4 are from the aisle.

The framework for each seat 200, 200a includes an outer side 205 supported by a rail 300 which forms part of and extends along an inner wall of the bus. An inner side 210 of the framework is supported by a pair of legs 215, 216 which include floor plates 217, 218 used to secure the legs to the floor of the bus. Further, the framework includes a side arm structure 220, and an angular strut 230 positioned generally below the side arm structure.

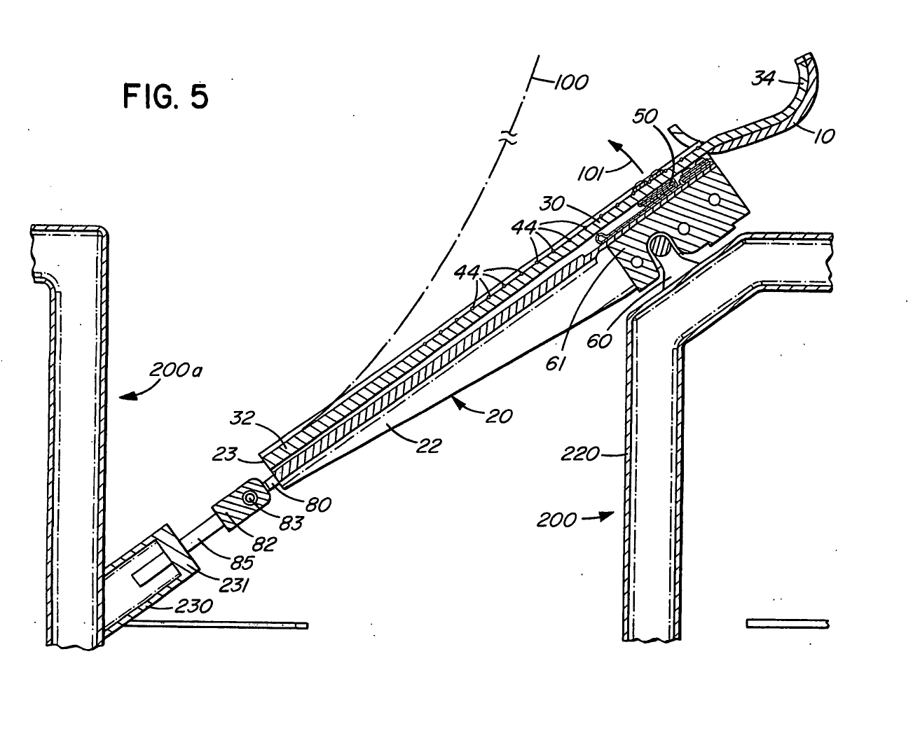

As best seen in FIG. 5, crossbar support 20 includes an elongated base member 22 extending upwardly and rearwardly from a lower end 23 mounted forward of seat 200 by means of a rod 80 which extends into a pivot connection 82. Pivot connection 82 includes a pivot pin 83 which extends transversely through rod 80, and a rod 85 which is threaded into a bracket 231 at the upper end of strut 230 of seat 200a. The threaded connection between rod 85 and bracket 231 allows length adjustments to be made so that support 20 can be precisely fitted between seats 200, 200a.

Crossbar support 20 also includes an elongated spring arm 30 extending longitudinally upwardly and rearwardly from a lower end 32 secured to the base member to a distal end 34 which is adapted to carry an end of a passenger safety crossbar 10.

Arm 30 has resilience for storing mechanical energy. Thus, when arm 30 is flexed from the normally unflexed position shown in FIG. 5 (viz. where arm 30 extends along base member 22) to a flexed position as indicated by broken line 100 (viz. where arm 30 bends in an arc away from base member 22), there is a resilient force tending to return the arm to its unflexed position.

As described below in more detail, crossbar support 20 further includes a plurality of mechanical fuses 40 to provide mechanical fuse resistance to flexing of arm 30. When the arm 30 flexed to the position indicated by line 100, the fuses will break or shear thereby absorbing and dissipating mechanical energy while arm 30 absorbs and stores mechanical energy.

Crossbar support 20 also includes a flexible strap 50 which is connected at one end to base member 22 and at the other to spring arm 30. In FIG. 5, strap 50 is compactly folded back and forth upon itself within base member 22. However, as indicated by arrow 101, it will be drawn outwardly with spring arm 30 when the arm flexes. When fully extended, the strap will limit further flexing of the arm.

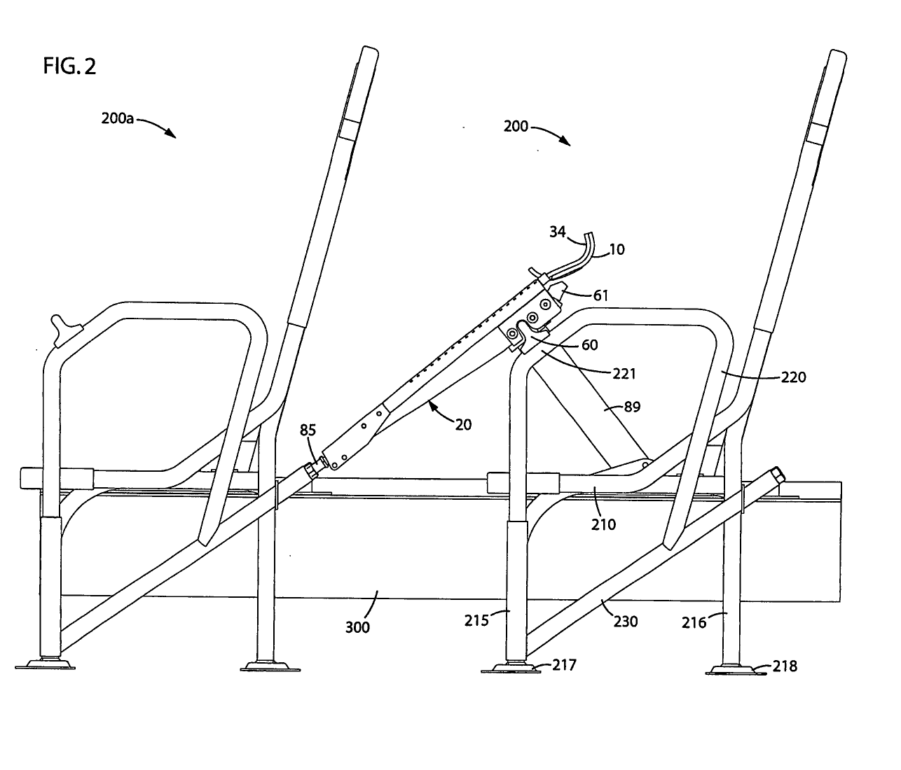

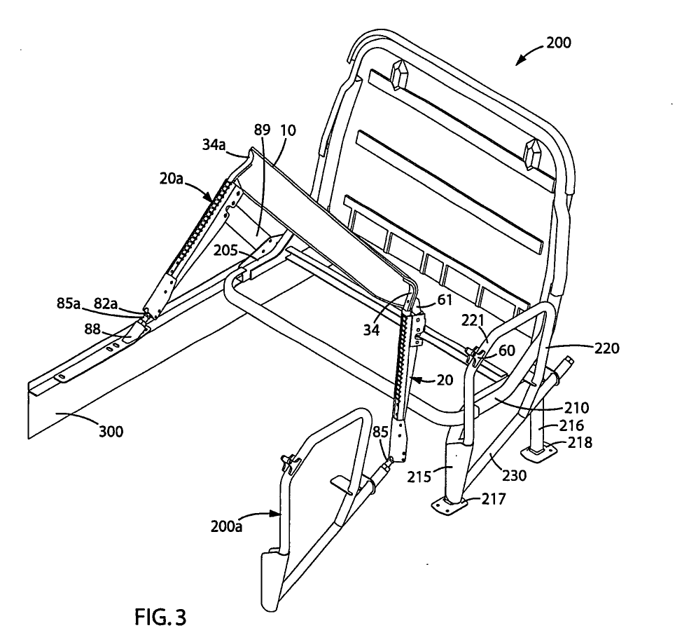

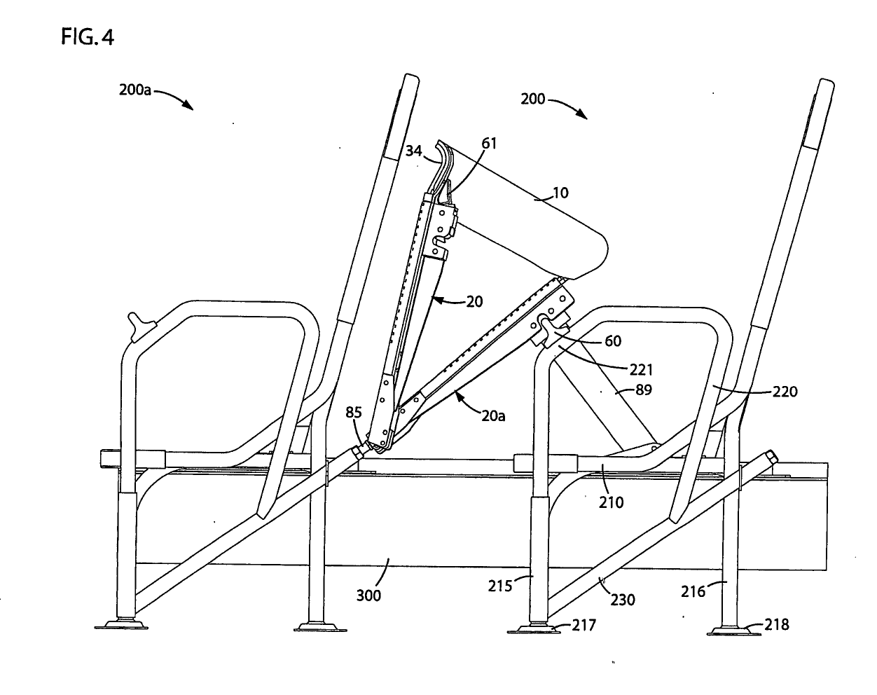

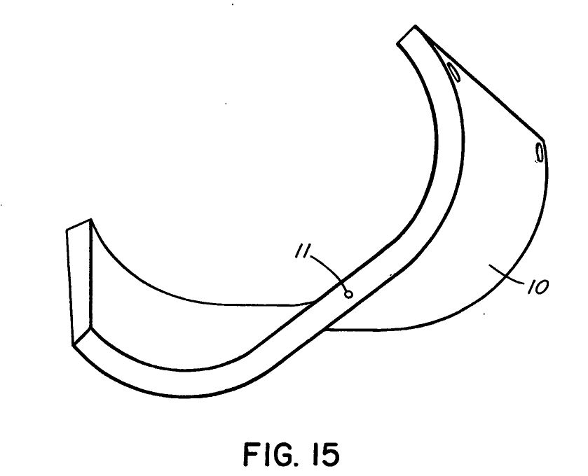

In FIGS. 1, 2 and 5, crossbar support 20 is latched in a closed position. To facilitate latching, one portion 60 of a conventional latching mechanism is carried by segment 221 of side arm structure 220 while a cooperating portion 61 is carried by crossbar support 20. When unlatched as shown in FIGS. 3 and 4, crossbar support 20 is held upwardly and away from side arm structure 220 by crossbar 10. This allows passengers easy access to and egress from the seating area provided by seat 200. More particularly, and as best seen in FIG. 15, crossbar 10 is formed from a resilient material with a longitudinal twist about its longitudinal axis 11. This is its normal, unstressed shape, and thus naturally holds crossbar support arm 20 in the open position shown in FIGS. 2 and 4. To then move crossbar support 20 to its closed position, a passenger normally will pull rearwardly on crossbar 10. As can be seen in FIGS. 1, 2 and 5, the longitudinal twist which is visible in FIG. 15 is then absent. When crossbar support 20 is subsequently unlatched, the resilience of crossbar 10 lifts the support back to its open position.

Referring to FIGS. 1 and 3, the structure of crossbar support 20a is substantially the same as that of crossbar support 20, its distal end 34a normally holding the end of crossbar 10 opposite to that normally held by distal end 34 of support 20. The lower end of support 20a is pivotally carried by a pivot connection 82a substantially the same as pivot connection 82. Pivot connection 82a includes a rod 85a which is threaded into bracket 88 mounted on rail 300, the latter of which is a normal part of a conventional school bus (not shown). The upper end of support 20a is held by a brace 89 such that support 20a extends substantially parallel to support 20.

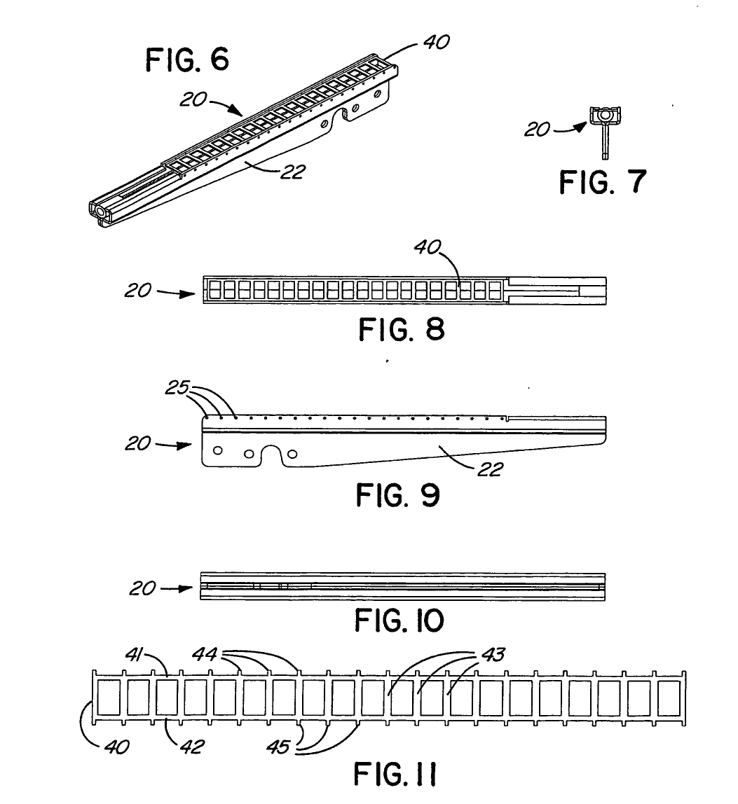

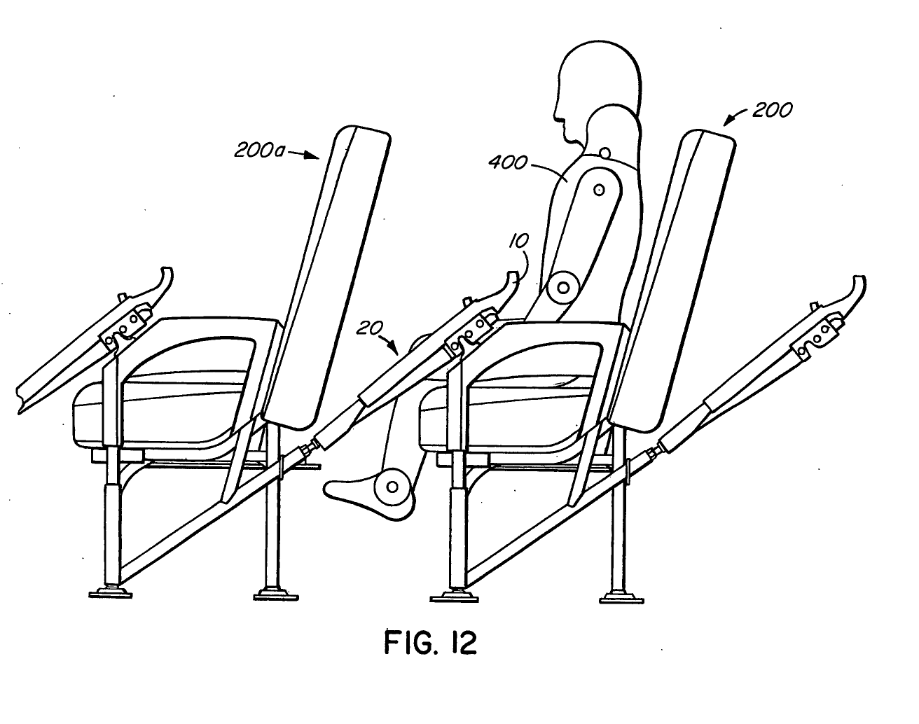

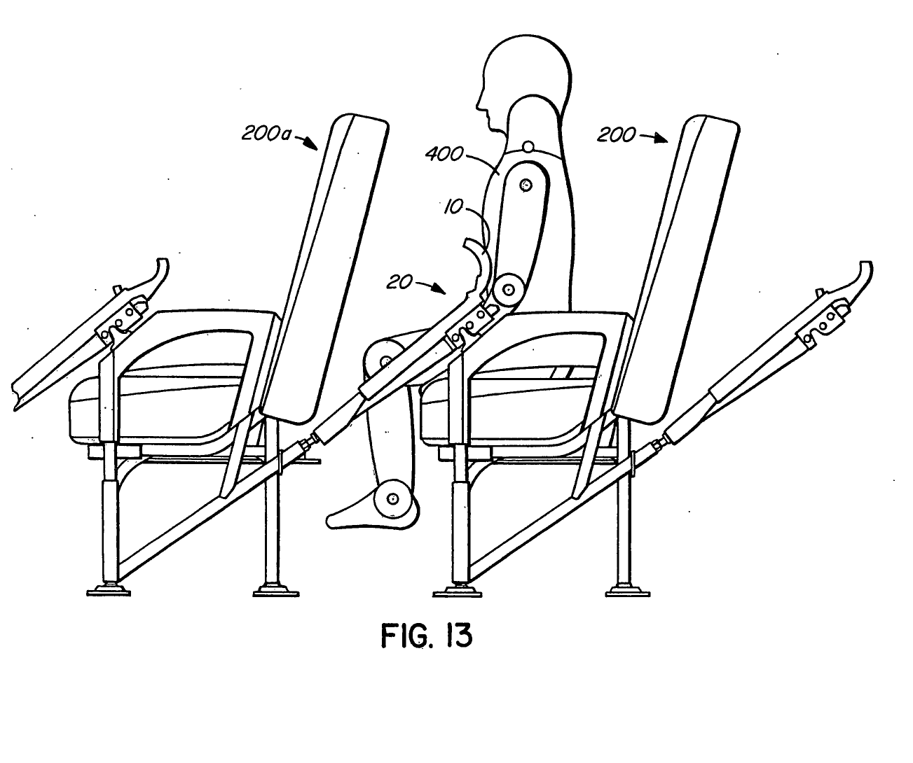

FIGS. 6 to 11 illustrate aspects of crossbar support 20 in more detail. The support 20 includes an elongated mechanical fuse strip 40 which extends over spring arm 30, and which is integrally formed from thin sheet steel. Strip 40 comprises a central portion having opposed longitudinally extending sides 41, 42 connected at spaced intervals by crosspieces 43, a first plurality of fuse tabs 44 extending transversely outward from side 41, and a second plurality of fuse tabs 45 extending transversely outward from side 42. All of the tabs are secured in slots 25 on opposed sides of base member 22. When spring arm 30 is flexed, it bears against the tabs and when flexed to a sufficient degree will break or shear the tabs thereby absorbing and dissipating mechanical energy.

As indicated above, a crossbar support may be mechanically fused by means other than the mechanical fuse strip that has been described. For example, with incidental structural modifications that will be readily apparent to those skilled in the art, individual shear pins could be generally positioned where each crosspiece 43 is positioned as shown in FIG. 3, and would serve to resist flexing of a spring arm such as spring arm 30. However, a potential disadvantage of shear pins is that when they do break shear they may leave ragged edges which in themselves may provide a heightened risk of injury in the circumstances of a crash.

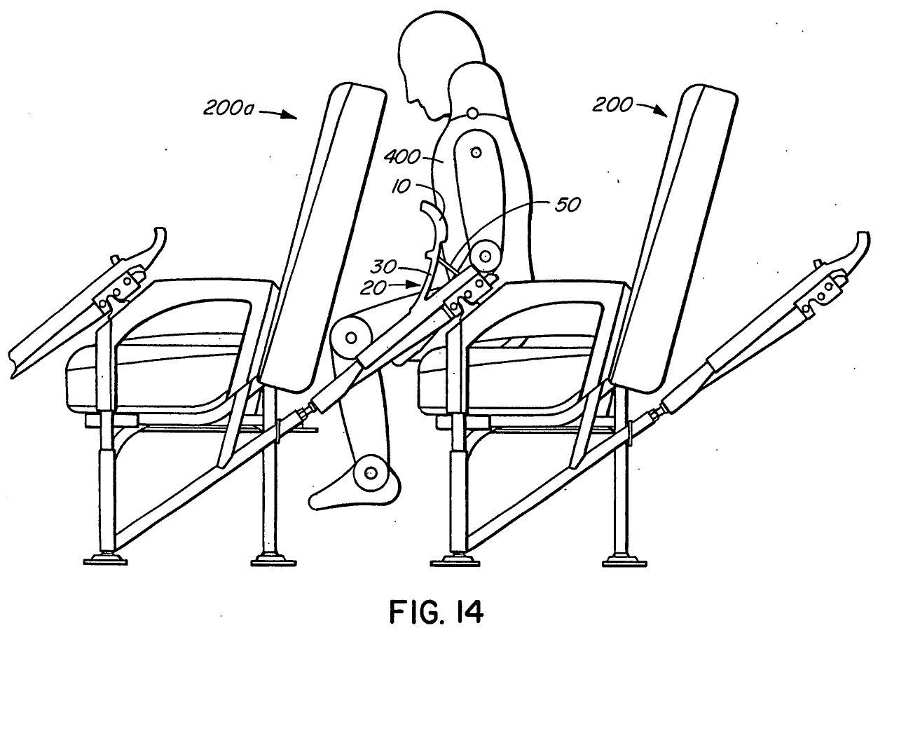

With a crash test dummy serving as a passenger 400, FIGS. 12 to 14 illustrate the use of the present invention in a representative manner. In FIG. 12, the situation is one of normal travel. Passenger 400 is seated rearwardly away from crossbar 10 which is carried by crossbar support 20. FIG. 13 depicts the situation at an early moment after a collision has occurred. Passenger 400 has been propelled forward and has impacted on crossbar 20. In response, the spring arm in support 20 has begun to flex. Crossbar 10 has moved slightly forwardly and upwardly in relation to seat 200. Subsequently, in FIG. 14, the momentum of passenger 400 has forced the spring arm of support 20 to a fully flexed position where further flexing is restrained by strap 50. With further reference to FIG. 14, it will be understood that when the forward momentum of the passenger 400 has ended then the stored energy in spring arm 30 will urge the passenger back towards seat 200. At all times crossbar support 20 has remained latched in its closed position.

Various modifications and changes to the embodiment that has been described can be made without departing from the scope of the present invention, and will undoubtedly occur to those skilled in the art. The invention is not to be construed as limited to the particular embodiment that has been described and should be understood as encompassing all those embodiments which are within the spirit and scope of the claims that follow.

1. An energy absorption device; comprising:
(a) an elongated base member;
(b) an elongated spring arm extending longitudinally from a first end secured to said base member to a distal end; said arm having resilience for storing mechanical energy when flexed from a normally unflexed position where said distal end is relatively near said base member to a flexed position where said distal end is relatively far from said base member; and
(c) mechanical fuse means for providing fuse resistance to the flexing of said arm from said unflexed position to said flexed position.

2. An energy absorption device; comprising:
(a) an elongated base member;
(b) an elongated spring arm extending longitudinally from a first end secured to said base member to a distal end; said arm having resilience for storing mechanical energy when flexed from a normally unflexed position where said distal end is relatively near said base member to a flexed position where said distal end is relatively far from said base member; and
(c) a plurality of mechanical fuses secured at spaced intervals along said base member, each fuse extending over said arm for providing fuse resistance to the flexing of said arm from said unflexed position to said flexed position.

3. A device as defined in claim 2, where each of said fuses is a shear pin.

4. An energy absorption device; comprising:
(a) an elongated base member;
(b) an elongated spring arm extending longitudinally from a first end secured to said base member to a distal end; said arm having resilience for storing mechanical energy when flexed from a normally unflexed position where said distal end is relatively near said base member to a flexed position where said distal end is relatively far from said base member; and
(c) an elongated mechanical fuse strip comprising a central portion extending lengthwise over said arm and a plurality of fuse tabs extending transversely outward from said central portion to said base member, each of said tabs being secured to said base member for providing fuse resistance to the flexing of said arm from said unflexed position to said flexed position.

5. A device as defined in claim 4, wherein said central portion of said strip and said tabs are integrally formed.

6. A device as defined in claim 5, wherein:
(a) said central portion comprises opposed longitudinally extending first and second sides connected by crosspieces at spaced intervals; and
(b) a first sub-plurality of said tabs extends transversely outward from said first side of said central portion, and a second sub-plurality of said tabs extends transversely outward from said second side of said central portion.

7. A device as defined in claim 1, wherein said distal end of said arm is adapted to carry an end of a passenger safety crossbar.

8. A device as defined in claim 1, further including a flexible strap connected at one end to said base member and at an opposed end to said arm, said strap having a length sized to limit said arm from flexing beyond a predetermined maximum flexed position.

9. A system for protecting a passenger seated in a vehicle on a vehicle seat, said system comprising a passenger safety crossbar extending between opposed ends, each of said ends being carried by an associated crossbar support, each of said crossbar supports comprising:
(a) an elongated base member extending upwardly and rearwardly from a lower end mounted in said vehicle forward of said seat;
(b) an elongated spring arm extending longitudinally upwardly and rearwardly from a lower end secured to said base member to a distal end; the associated end of said crossbar being secured to said distal end, said arm having resilience for storing mechanical energy when flexed from a normally unflexed position where said distal end is relatively near said base member to a flexed position where said distal end is relatively far from said base member; and
(c) mechanical fuse means for providing fuse resistance to the flexing of said arm from said unflexed position to said flexed position.

10. A system for protecting a passenger seated in a vehicle on a vehicle seat, said system comprising a passenger safety crossbar extending between opposed ends, each of said ends being carried by an associated crossbar support, each of said crossbar supports comprising:
(a) an elongated base member extending upwardly and rearwardly from a lower end mounted in said vehicle forward of said seat;
(b) an elongated spring arm extending longitudinally upwardly and rearwardly from a lower end secured to said base member to a distal end; the associated end of said crossbar being secured to said distal end, said arm having resilience for storing mechanical energy when flexed from a normally unflexed position where said distal end is relatively near said base member to a flexed position where said distal end is relatively far from said base member; and
(c) a plurality of mechanical fuses secured at spaced intervals along said base member, each fuse extending over said arm for providing fuse resistance to the flexing of said arm from said unflexed position to said flexed position.

11. A system as defined in claim 10, where each of said fuses is a shear pin.

12. A system for protecting a passenger seated in a vehicle on a vehicle seat, said system comprising a passenger safety crossbar extending between opposed ends, each of said ends being carried by an associated crossbar support, each of said crossbar supports comprising:
(a) an elongated base member extending upwardly and rearwardly from a lower end mounted in said vehicle forward of said seat;
(b) an elongated spring arm extending longitudinally upwardly and rearwardly from a lower end secured to said base member to a distal end; the associated end of said crossbar being secured to said distal end, said arm having resilience for storing mechanical energy when flexed from a normally unflexed position where said distal end is relatively near said base member to a flexed position where said distal end is relatively far from said base member; and
(c) an elongated mechanical fuse strip comprising a central portion extending lengthwise over said arm and a plurality of fuse tabs extending transversely outward from said central position to said base member, each of said tabs being secured to said base member for providing fuse resistance to the flexing of said arm from said unflexed position to said flexed position.

13. A system as defined in claim 12, wherein said central portion of said strip and said tabs are integrally formed.

14. A system as defined in claim 13, wherein:
(a) said central portion comprises opposed longitudinally extending first and second sides connected by crosspieces at spaced intervals; and
(b) a first sub-plurality of said tabs extends transversely outward from said first side of said central portion, and a second sub-plurality of said tabs extends traversely outwardly from said second side if said central portion.

15. A system as defined in claim 9, each of said crossbar supports further including an associated flexible strap connected at one end to the base member of the associated crossbar support and at an opposed end to the arm of the associated crossbar support, said strap having a length sized to limit the arm of the associated crossbar support from flexing beyond a predetermined maximum flexed position.

16. A system as defined in claim 9, wherein said lower end of at least one of said base members is pivotally mounted in said vehicle to permit movement of said crossbar from a closed position protecting a passenger while seated in said seat to an open position permitting passenger access to and egress from said seat.

17. A system as defined in claim 9, wherein:
(a) said lower end of one of said base members is pivotally mounted in said vehicle to permit movement of said crossbar from a closed position protecting a passenger while seated in said seat to an open position permitting passenger access to and egress from said seat;
(b) said system further including means for releasably latching said one of said base members to a frame member of said seat.

18. A system as defined in claim 17, wherein said crossbar is formed from a resilient material for springing said crossbar to said open position when said one of said base members is unlatched from said frame member.
